(19) United States
(12) Patent Application Publication
(10) Pub. No.: US 2006/0228493 A1
(43) Pub. Date: Oct. 12, 2006

(54) Method of plating on a glass base plate and a method of manufacturing a perpendicular magnetic recording medium

(75) Inventors: Akira Iso, Minami-Alps City (JP); Youichi Tei, Matsumoto City (JP); Hajime Kurihara, Minami-Alps City (JP)

Correspondence Address: ROSSI, KIMMS & McDOWELL LLP., P.O. BOX 826, ASHBURN, VA, 20146-0826, US

(73) Assignee: Fuji Electric Device Technology Co., Ltd., Shinagawa-ku (JP)

(21) Appl. No.: 11/374,374

(22) Filed: Mar. 13, 2006

(30) Foreign Application Priority Data
Apr. 8, 2005 (JP) JPPA 2005-112056

(51) Int. Cl. B05D 1/18

(52) U.S. Cl. 427/553; 427/443.1; 427/301

(57) ABSTRACT

A plating method on a glass base plate is disclosed. The method allows an electroless plating film to be formed on a base plate composed of a glass material with excellent adhesivity through a process that removes alkaline and alkaline earth metals on the surface of the base plate. Also disclosed is a method of manufacturing a magnetic recording medium employing the method of plating on a glass base plate. Before forming a plating film in a step of electroless plating, a series of surface treatments are conducted on the surface of the base plate composed of a glass material. The series of surface treatments comprises at least an ultraviolet light irradiation, an etching treatment, an adhesion layer formation treatment, a catalyst layer formation treatment, and a catalyst activation treatment.

### CROSS REFERENCE TO RELATED APPLICATIONS

This application is based on, and claims priority to, Japanese Application No. 2005-112056, filed on Apr. 8, 2005, the contents of which are incorporated herein by reference.

### BACKGROUND OF THE INVENTION

A. Field of the Invention

The present invention relates to a method of plating on a base plate composed of a glass material and a method of manufacturing a perpendicular magnetic recording medium using the plating method. In particular, the methods are beneficially applied to forming an electroless plating film on a glass substrate used in a hard disk as a magnetic recording medium.

B. Description of the Related Art

Magnetic recording media (hard disks) installed in hard disk drives (HDDS) used for external storage devices of computers are required to have large storage capacity for mounting on an AV apparatus and high recording density so that they can accommodate a small sized disk. In order to meet these requirements, glass substrates are replacing aluminum alloy substrates as the substrate material, in view of the superior flatness and strength of the former. As to a recording system, the in-plane magnetic recording system is being replaced by the perpendicular magnetic recording system, which allows higher density recording.

A perpendicular magnetic recording medium (see, for example, Japanese Patent Publication No. S58-91) needs to have a relatively thick layer called a soft magnetic underlayer that has a thickness of 0.3 to 3.0 μm deposited on the substrate. This layer usually is deposited using a sputtering method, but this leads to a problem of high cost. It is desirable, therefore, to deposit the layer by an electroless plating method, which achieves high productivity.

A substrate of an aluminum alloy allows an electroless plating film exhibiting satisfactory adhesivity to be formed with no problem. However, in the case of a glass substrate, the electroless plating film cannot be formed directly on the glass substrate due to the chemical property of glass. Accordingly, a technique has been proposed (see, for example, Japanese Unexamined Patent Application Publication No. 2000-163743) in which an electroless plating film is formed after forming an adhesion layer of silane coupling agent on the glass substrate.

In this method, the silane coupling agent dissolves in water and the ethoxyl group or methoxyl group of the silane coupling agent is transformed to a silanol group, which binds to a hydroxyl group (silanol group) on the surface of the glass substrate through a hydrogen bond. After a dehydration treatment, adhesion is accomplished with a firm chemical bond. Therefore, this method differs from the sensitization—activation method, which utilizes an anchoring effect by surface coarsening, and provides a plating film with satisfactory adhesivity even on a flat substrate surface.

In the method of using a silane coupling agent in the adhesion layer, a firm adhesion layer is formed by the chemical bond between the silanol groups of the silane coupling agent and the hydroxyl groups of the glass substrate surface. However, those components of the silane coupling agent that are simply adsorbed or attached by hydrogen bonds do not achieve a chemical bond, causing poor adhesion of the plating film.

Possible reasons to hinder the chemical bond include contamination on the substrate surface with oils or fats and alkaline and alkaline earth metals contained in the glass material. While the contamination on the glass surface can be eliminated by alkaline degreasing or hydrofluoric acid etching, elimination of the alkaline and alkaline earth metals, being contained within the glass material itself, is very difficult.

The present invention is directed to overcoming or at least reducing the effects of one or more of the problems set forth above.

### SUMMARY OF THE INVENTION

In view of the above problem, an object of the present invention is to provide a method of plating on a glass base plate, the method allowing an electroless plating film to be formed with satisfactory adhesivity by removing alkaline and alkaline earth metals on the surface of a base plate composed of a glass material. Another object of the invention is to provide a method of manufacturing a magnetic recording medium employing the method of plating,

To accomplish these and other objects, a method of plating on a glass base plate of the invention comprises a series of treatments sequentially conducted on a surface of a base plate composed of a glass material, the series of treatments including at least a step of ultraviolet light irradiation treatment, a step of etching treatment, a step of adhesion layer formation treatment, a step of catalyst layer formation treatment, a step of catalyst layer activation treatment, and a process of electroless plating.

Advantageously, the step of ultraviolet light irradiation treatment is conducted using ultraviolet light with a wavelength of at least 200 nm; the step of etching treatment is conducted using hydrofluoric acid; the step of adhesion layer formation treatment is conducted using a silane coupling agent; the step of catalyst layer formation treatment is conducted using a palladium catalyst; and the step of catalyst activation treatment is conducted using hypophosphorous acid.

A method of manufacturing a magnetic recording medium of the invention comprises a procedure of electroless plating on a glass substrate employing the method of plating on a glass base plate and a procedure including at least a step of forming a magnetic recording layer on the electroless plating film.

In the method of the invention, alkaline and alkaline earth metals contained in the glass in a form of oxide or hydrate are decomposed by irradiation of ultraviolet light. Because the chemical bonds have been broken for the alkaline and alkaline earth metals subjected to the ultraviolet light irradiation and decomposed, the following step of etching removes the alkaline and alkaline earth metals from the glass surface.

Irradiation of ultraviolet light having a wavelength shorter than 200 nm breaks the bond of SiO₂ that is the skeleton of glass. Wavelength of the ultraviolet light to be irradiated is preferably in the range of 200 nm to 350 nm. The light in this wavelength range avoids the breakage of SiO₂ bond on the one hand while still allowing the alkaline and alkaline earth metals to be selectively etched.

Use of hydrofluoric acid in the etching step after the ultraviolet light irradiation improves adhesivity. This is an effect of the hydrofluoric acid decomposing to fluorine and hydrogen with the fluorine bonding to the alkaline metal and the hydrogen generating silanol group (Si—OH) on the glass surface.

The method of plating on a glass substrate according to the invention provides an electroless plating film without blistering that exhibits satisfactory adhesivity on the glass substrate. Consequently, a magnetic recording medium exhibiting excellent adhesivity is obtained by forming an electroless plating film on a glass substrate employing the method of plating on a glass base plate of the invention and forming a magnetic recording layer on the electroless plating film. In particular, by forming a soft magnetic plating film employing the method of plating a perpendicular magnetic recording medium using a glass substrate can be obtained with good soft magnetic performance and satisfactory adhesivity.

The following describes some preferred embodiments to manufacture a perpendicular magnetic recording medium by forming a soft magnetic plating film on a glass substrate applying a method of plating on a glass base plate according to the invention and forming a magnetic recording layer on the soft magnetic plating film. The method of plating on a glass base plate according to the invention is, however, not limited to this application. The same effects are obtained when a nonmagnetic or magnetic plating film is formed by an electroless plating method on a base plate of a glass material in general, with a thickness of at least 1 μm and with good adhesivity and homogeneity.

The base plates of a glass material in general include for example, glass for flat panel displays such as liquid crystal, PDP, FED, EL, and the like, glass for information devices such as copiers, and further, glass for optical communication devices, cars, medical equipment, and building materials.

### BRIEF DESCRIPTION OF THE DRAWINGS

The foregoing advantages and features of the invention will become apparent upon reference to the following detailed description and the accompanying drawings, of which:

FIG. 1 shows a procedure in a method of plating on a glass base plate of an embodiment according to the invention;

FIG. 2 is a schematic drawing showing a layout in ultraviolet light irradiation on a glass substrate of an embodiment according to the invention;

FIG. 3 shows an M-H loop (magnetization curve) of a plated substrate of Example 2 measured by a VSM;

FIG. 4 shows a result of surface observation by OSA on an embodiment example of a perpendicular magnetic recording medium; and

FIG. 5 shows a result of surface observation by OSA on an example of a perpendicular magnetic recording medium including magnetic domain walls.

The figures employ the following reference numbers:
S1 step of ultraviolet light irradiation
S2 step of etching
S3 step of adhesion layer formation
S4 step of catalyst layer formation
S5 step of catalyst activation
S6 step of electroless plating
1 glass substrate
2 low pressure mercury lamp
3 substrate holder
4 dark box

### DETAILED DESCRIPTION OF SPECIFIC EMBODIMENTS

Embodiment of a Method of Plating on a Glass Base Plate

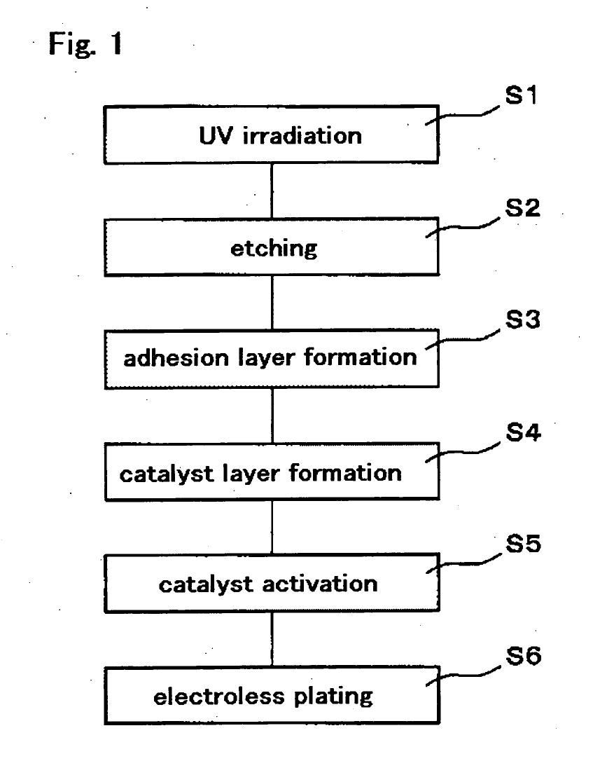

As shown in FIG. 1, a method of plating on a glass base plate in an embodiment according to the invention comprises a step of ultraviolet light irradiation S1, a step of etching S2, a step of adhesion layer formation S3, a step of catalyst layer formation S4, a step of catalyst activation S5, and a step of electroless plating S6. These steps are described below.

Step of Ultraviolet Light Irradiation S1

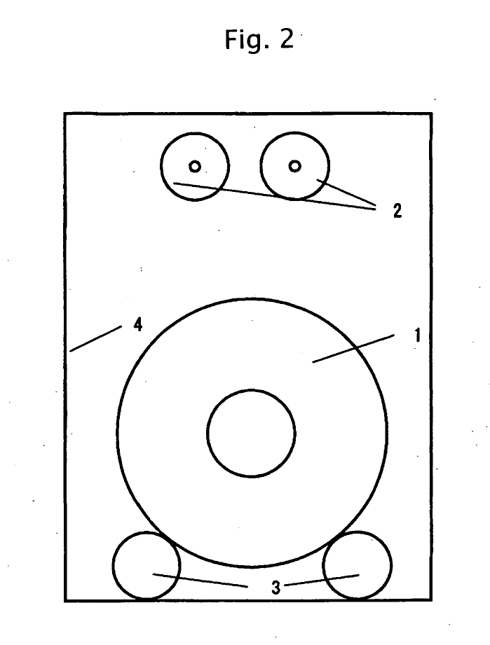

In this step, shown in FIG. 2, a disk-shaped glass substrate for a magnetic recording medium is prepared as a base plate for forming an electroless plating film. Glass substrate 1 is held vertically with substrate holder 3 in dark box 4 and subjected to ultraviolet light (UV) irradiation from above by low pressure mercury lamp 2. In this arrangement, ultraviolet light irradiation is performed on both surfaces of glass substrate 1.

The effect of the ultraviolet light irradiation can be seen with reference to Table 1, which shows values of binding energy of principal compounds of glass and compounds of alkaline and alkaline earth metals contained in glass, together with the converted wavelengths.

TABLE 1

| glass component | binding energy | converted wavelength |
|---|---|---|
| SiO₂ | 150 kcal/mol | 191 nm |
| SiO | 105 kcal/mol | 272 nm |
| LiOH | 105 kcal/mol | 272 nm |
| KOH | 90 kcal/mol | 318 nm |
| NaOH | 86 kcal/mol | 332 nm |
| CaO | 91 kcal/mol | 314 nm |
| MgO | 88 kcal/mol | 325 nm |

As is apparent from Table 1, the alkaline and alkaline earth metals contained in glass in a form of oxide or hydrate can be decomposed by breaking the chemical bonds with ultraviolet light having a wavelength shorter than 350 nm. Therefore, the alkaline and alkaline earth metals can be removed from the glass surface by an etching step after the ultraviolet light irradiation.

Irradiation of ultraviolet light having a wavelength shorter than 200 nm breaks the bonds of SiO₂ that is the skeleton of glass. Therefore, the wavelength of ultraviolet light to be irradiated is preferably in the range of 200 nm to 350 nm. The light in this wavelength range avoids the breakage of SiO₂ bond on the one hand while still allowing the alkaline and alkaline earth metals to be selectively etched.

Use of hydrofluoric acid in etching step after the ultraviolet light irradiation improves adhesivity. This is an effect of the hydrofluoric acid decomposing to fluorine and hydrogen, the fluorine bonding to the alkaline metal and the hydrogen generating silanol group (Si—OH) on the glass surface.

On the thus obtained glass substrate surface, an adhesion layer is formed of a silane coupling agent, a catalyst layer is formed of palladium, a catalyst activation treatment is conducted using hypophosphorous acid, and then a film is deposited by an electroless plating method. Thus, a soft magnetic film or a nonmagnetic film exhibiting satisfactory adhesivity can be obtained.

Step of Etching S2

In this step, an etching treatment is conducted on the glass substrate after the ultraviolet light irradiation treatment, by dipping the glass substrate in a treatment liquid. By this treatment, alkaline and alkaline earth metals on the glass substrate surface can be easily removed since the chemical bonds with the alkaline and alkaline earth metals have been broken by the ultraviolet light irradiation treatment.

An acid etching treatment using an aqueous solution of diluted acid as a treatment liquid removes alkaline and alkaline earth metals on the glass substrate surface and simultaneously increases silanol groups that bind to silane coupling agent. The effects are significant when hydrofluoric acid treatment, or a sulfuric acid treatment followed by a hydrofluoric acid treatment, is conducted.

As a pre-treatment before such an acid etching treatment, an alkali degreasing treatment (alkali etching treatment) using an aqueous solution of potassium hydroxide (KOH) or the like is preferably conducted to clean the glass substrate surface. The glass substrate after each treatment is rinsed with pure water and transferred to the next step without drying.

Step of Adhesion Layer Formation S3

In this step, an adhesion layer is formed by dipping the glass substrate after the etching treatment in an aqueous solution of a silane coupling agent. The glass substrate after the dipping treatment is rinsed with pure water and transferred to the next step without drying.

A silane coupling agent to form an adhesion layer is preferably an amino silane coupling agent, for example, KBE 903, KBM 903, KBE 603, or KBM 603 manufactured by Shin-Etsu Chemical Co., Ltd.

Step of Catalyst Layer Formation S4

In this step, a catalyst layer for a catalyst in the electroless plating process is formed by dipping the glass substrate after forming the adhesion layer into a palladium catalyst solution, preferably an aqueous solution of palladium chloride (PdCl₂). The glass substrate after the dipping treatment is rinsed with pure water and transferred to the next step without drying.

Step of Catalyst Activation S5

In this step, the glass substrate having the catalyst layer is dipped in an aqueous solution of hypophosphorous acid (H₃PO₂) to bind the palladium of the catalyst layer formed by applying the palladium catalyst solution to the adhesion layer and, at the same time, to activate the catalyst metal. Excessive free palladium is removed in this step. The glass substrate after the dipping treatment is rinsed with pure water and transferred to the next step without drying.

Step of Electroless Plating S6

In this step, electroless plating is conducted using the palladium catalyst of the catalyst layer by dipping the glass substrate after the catalyst activation treatment into an electroless plating liquid. The electroless plating liquid can be selected from commercially available plating liquid corresponding to a required plating film.

Through the above procedure, a soft magnetic film or a nonmagnetic film for use in a magnetic recording medium, such as CoNiP film or NiP film, can be formed by an electroless plating method with satisfactory adhesivity.

Embodiment of a Method of Manufacturing a Magnetic Recording Medium

The following describes an example for manufacturing a perpendicular magnetic recording medium employing a method of manufacturing a magnetic recording medium according to the invention.

First, a soft magnetic plating film of CoNiP or the like is formed on a glass substrate with a disk shape employing a method of plating on a glass base plate of the embodiment of the invention as described above. As necessary, the substrate surface is polished, flattened and textured, and then cleaned and dried. Then a nonmagnetic seed layer, a magnetic recording layer of Co—Cr—Pt—SiO₂ or the like, and a protective layer of carbon are sequentially deposited on the substrate by a sputtering method. Through this procedure, a perpendicular magnetic recording medium comprising a soft magnetic plating film formed by an electroless plating method on a glass substrate can be manufactured, the soft magnetic plating film being utilized as at least a part of a soft magnetic underlayer.

Following the aspect of embodiment of the invention as described above, a soft magnetic plating film without blistering can be formed on a glass substrate exhibiting satisfactory adhesivity, thereby providing a perpendicular magnetic recording medium exhibiting good soft magnetic performance and adhesivity using a glass substrate.

Specific embodiment examples according to the invention are described below.

Examples of a Method of Plating on a Glass Base Plate

### Example 1

### Step of Ultraviolet Light Irradiation S1

In this step as shown in FIG. 2, disk-shaped glass substrate 1 for a magnetic recording medium was held vertically with substrate holder 3 in dark box 4 and subjected to ultraviolet light (UV) irradiation with a wavelength of 185 nm and an intensity of 10 mW/cm² from above by low pressure mercury lamp 2 on both surfaces of the glass substrate 1 for 30 minutes. The substrate was not rotated.

Step of Etching S2

The surface of the glass substrate after the ultraviolet irradiation was subjected to the etching treatment consisting of the etching processes 1 through 3 below.

(1) Etching Process 1

First, the glass substrate was dipped in an aqueous solution of potassium hydroxide. The treatment liquid was prepared by adding 2,700 g of KOH to 36 L of pure water and heating to 50° C., and the glass substrate was dipped in the treatment liquid for 3 minutes. During dipping, the glass substrate was rotated at 20 rpm for the substrate surface to be homogeneously treated. After completion of the above treatment, the glass substrate was thoroughly rinsed with pure water and transferred to the next process without drying.

(2) Etching Process 2

Next, the glass substrate was dipped in an aqueous solution of sulfuric acid. The treatment liquid was prepared by adding 36 mL of sulfuric acid to 36 L of pure water and the glass substrate was dipped in the treatment liquid for 3 minutes. During dipping, the glass substrate was rotated at 20 rpm for the substrate surface to be homogeneously treated. After completion of the above treatment, the glass substrate was thoroughly rinsed with pure water and transferred to the next process without drying.

(3) Etching Process 3

Next, the glass substrate was dipped in an aqueous solution of hydrofluoric acid. The treatment liquid was prepared by adding 9 mL of hydrofluoric acid to 36 L of pure water and the glass substrate was dipped in the treatment liquid for 3 minutes. During dipping, the glass substrate was rotated at 20 rpm for the substrate surface to be homogeneously treated. After completion of the above treatment, the glass substrate was thoroughly rinsed with pure water and transferred to the next process without drying.

Step of Adhesion Layer Formation S3

Next, the glass substrate was dipped in an aqueous solution of a silane coupling agent. The treatment liquid was prepared by adding 720 mL of KBE 603 (manufactured by Shin-Etsu Chemical Co., Ltd.) to 36 L of pure water and the glass substrate was dipped in the treatment liquid for 10 minutes. During dipping, the glass substrate was rotated at 20 rpm for the substrate surface to be homogeneously treated. After completion of the above treatment, the glass substrate was thoroughly rinsed with pure water and transferred to the next process without drying.

Step of Catalyst Layer Formation S4

Next, the glass substrate was dipped in an aqueous solution of palladium chloride. The treatment liquid was prepared by adding 1,080 mL of Activator 7331 (manufactured by Meltex Inc.) and 54 mL of KOH at a concentration of 0.1 mol/L to 36 L of pure water and the glass substrate was dipped in the treatment liquid for 10 minutes. During dipping, the glass substrate was rotated at 20 rpm for the substrate surface to be homogeneously treated. After completion of the above treatment, the glass substrate was thoroughly rinsed with pure water and transferred to the next process without drying.

Step of Catalyst Activation S5

Next, the glass substrate was dipped in an aqueous solution of hypophosphorous acid. The treatment liquid was prepared by adding 360 mL of PA7340 (manufactured by Meltex Inc.) to 36 L of pure water and the glass substrate was dipped in the treatment liquid for 2 minutes. During dipping, the glass substrate was rotated at 20 rpm for the substrate surface to be homogeneously treated. After completion of the above treatment, the glass substrate was thoroughly rinsed with pure water and transferred to the next process without drying.

Step of Electroless Plating S6

Next, the glass substrate after the pre-treatment of surface treatments described above was dipped into electroless plating bath, to deposit a CoNiP film 3 μm thick on the glass substrate. In this step of electroless plating, the composition of plating liquid was: 5 g/L of cobalt sulfate 7 hydrate, 5 g/L of nickel sulfate 6 hydrate, 20 g/L of sodium hypophophite, 60 g/L of sodium citrate, and 30 g/L of boric acid. The total volume of the plating bath was 75 L. The plating temperature was 85° C., and pH was adjusted to 8 with sodium hydroxide. During dipping, the glass substrate was rotated at 20 rpm to obtain a homogeneous plating film.

Through the above procedure, a plated substrate for a perpendicular magnetic recording medium was manufactured that has a soft magnetic film of CoNiP film formed on a glass substrate by means of an electroless plating method.

### Example 2

A plated substrate was manufactured in the same manner as in Example 1 except that the wavelength of irradiated ultraviolet light in the step of ultraviolet light irradiation S1 was changed to 254 nm.

### Example 3

A plated substrate was manufactured in the same manner as in Example 1 except that the wavelength of irradiated ultraviolet light in the step of ultraviolet light irradiation S1 was changed to 365 nm.

### Example 4

A plated substrate was manufactured in the same manner as in Example 2 except that the etching processes 2 and 3 in the step of etching S2 were omitted.

### Example 5

A plated substrate was manufactured in the same manner as in Example 2 except that the etching process 3 in the step of etching S2 was omitted.

### Example 6

A plated substrate was manufactured in the same manner as in Example 2 except that the etching process 2 in the step of etching S2 was omitted.

### Comparative Example

A plated substrate was manufactured in the same manner as in Example 1 except that the step of ultraviolet light irradiation S1 was omitted.

Evaluation

Six sheets of plated substrates were manufactured for every Examples 1 through 6 and Comparative Example. On each of those plated substrates, evaluation was performed for blistering of the plated film by visual observation and for adhesivity of the plated film by cross cut test (in accordance with JIS K5600-5-6). The results are shown in Tables 3 and 4. In the tables, the column of “occurrence of blistering” indicates the number of plated substrates in which blistering occurred, and the column of “adhesivity Lv” indicates the averaged Lv value over the six sheets of plated substrates, on each of which the cross cut test was conducted. Table 2 shows the classification of the adhesivity level.

TABLE 2
Classification of adhesivity level in the cross cut test

| | |
|---|---|
| Lv. 1 | peeling with a tape |
| Lv. 2 | peeling by cross cutting (2 mm × 2 mm) |
| Lv. 3 | peeling with a tape after cross cutting |
| Lv. 4 | partial peeling with a tape after cross cutting |
| Lv. 5 | no peeling after cross cutting |

TABLE 3

| | wavelength of | occurrence of | |
|---|---|---|---|
| | irradiated UV | blistering | adhesivity level Lv |
| Comp Ex | untreated | 6/6 sheets | 2.0 |
| Example 1 | 185 nm | 3/6 sheets | 4.3 |
| Example 2 | 254 nm | 0/6 sheets | 5.0 |
| Example 3 | 365 nm | 3/6 sheets | 3.2 |

It is apparent from the data for Examples 1 through 3 and Comparative Example that the irradiation of ultraviolet light is effective to suppress blistering and to improve adhesivity. Irradiation of ultraviolet light at a wavelength of 254 nm (Example 2) in particular, provided the best results with respect to both blistering and adhesivity. Irradiation of ultraviolet light at a wavelength of 185 nm (Example 1) changed the glass substrate to a yellow color, suggesting decomposition of the glass skeleton. It is presumed that this decomposition caused the blistering and degradation in adhesivity in Example 1 as compared with the best example of Example 2. Irradiation of ultraviolet light at a wavelength of 365 nm (Example 3) does not decompose the compounds of alkaline and alkaline earth metals sufficiently, which presumably caused the blistering and degradation in adhesivity in Example 3 as compared with the best example of Example 2. Thus, it has been demonstrated that irradiation of ultraviolet light is effective to suppress blistering and improve adhesivity, and preferable wavelengths are in the range of 200 nm to 350 nm.

TABLE 4

| | type of | occurrence of | adhesivity level |
|---|---|---|---|
| | etching | blistering | Lv |
| Example 4 | KOH only | 6/6 sheets | 3.7 |
| Example 5 | sulfuric acid | 4/6 sheets | 4.7 |
| Example 6 | hydrofluoric acid | 1/6 sheets | 5.0 |
| Example 2 | sulfuric acid and | 0/6 sheets | 5.0 |
| | hydrofluoric acid | | |

It is apparent from the data for Examples 2 and 4 through 6 that the etching after irradiation of ultraviolet light is effective to suppress blistering and to improve adhesivity. Especially, the etching using treatment liquid containing hydrofluoric acid is more effective.

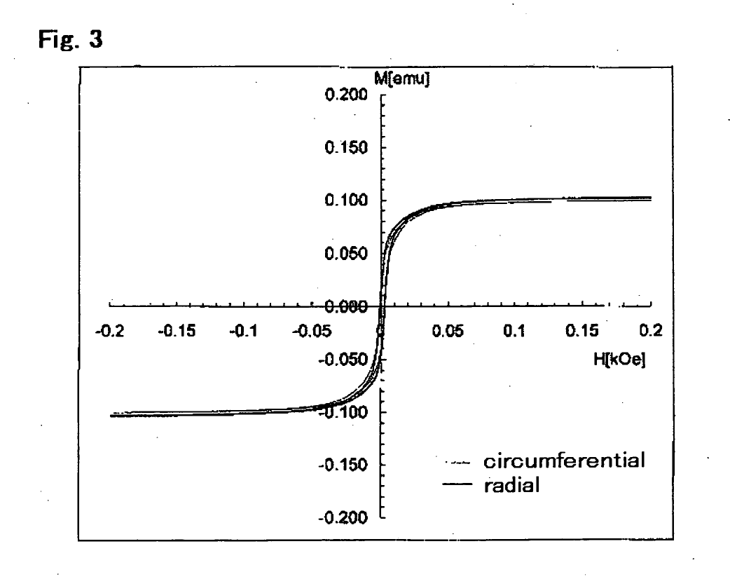

In order to utilize a soft magnetic underlayer in a perpendicular magnetic recording medium, the CoNiP film formed by the electroless plating must exhibit a soft magnetic property. Accordingly, a magnetic property was measured on the plated substrate of Example 2, which exhibited good external appearance, using a VSM (vibrating sample magnetometer). FIG. 3 shows an M-H loop (magnetization curve) measured by the VSM. An isotropic and favorable soft magnetic property has been demonstrated.

Example of a Method of Manufacturing a Magnetic Recording Medium

In the examples of a method of manufacturing a magnetic recording medium according to the invention, the plated substrates of Example 2 were used, which exhibited good external appearance and soft magnetic property. The plated substrate was subjected to a surface flattening treatment by polishing, scrub cleaning using a neutral detergent and PVA sponge, alkaline detergent rinsing (with 2% Semiclean, pH=12, a product of Yokohama Oils and Fats Industry Co., Ltd.), enough rinsing using ultra pure water of more than 18 MΩ, and steam drying using isopropyl alcohol. After that, a soft magnetic auxiliary layer of Co—Zr—Nb, a nonmagnetic seed layer of Ir—Mn, a magnetic recording layer of Co—Cr—Pt—SiO₂, and a carbon protective layer were sequentially formed on the plated substrate. Thus, a perpendicular magnetic recording medium was manufactured.

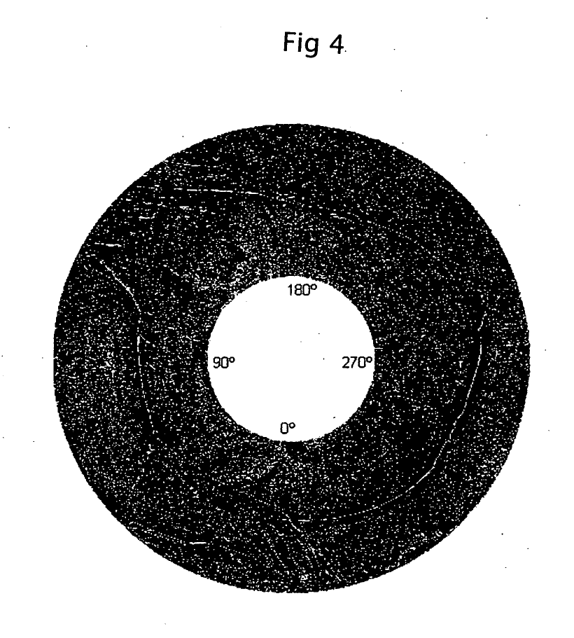

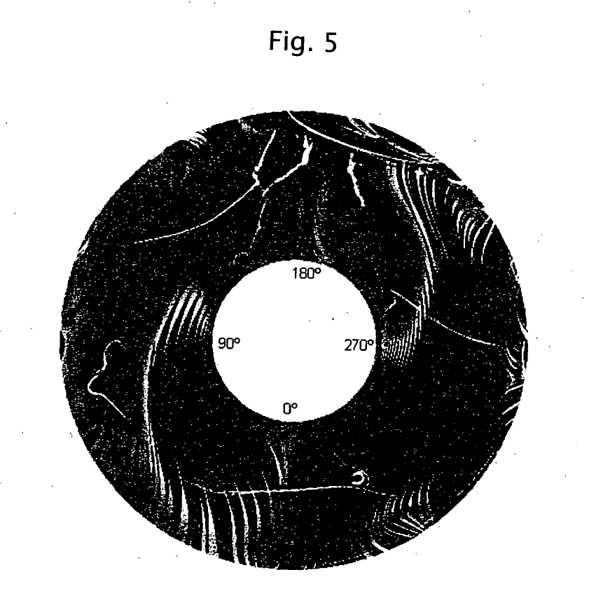

On this perpendicular magnetic recording medium, evaluation of magnetic domain walls was conducted using an OSA (optical surface analyzer: OSA-5100 manufactured by Candela Instruments). The result is shown in FIG. 4, showing a good medium without any magnetic domain wall. When magnetic domain walls exist, the stripe patterns are observed as shown in FIG. 5.

Thus, a method of plating on a glass base plate has been described according to the present invention. Many modifications and variations may be made to the techniques and structures described and illustrated herein without departing from the spirit and scope of the invention. Accordingly, it should be understood that the devices and methods described herein are illustrative only and are not limiting upon the scope of the invention.

What is claimed is:

1. A method of plating on a glass base plate, the method comprising:
a series of treatments sequentially conducted on a surface of a base plate composed of a glass material, the series of treatments including at least
an ultraviolet light irradiation treatment,
an etching treatment,
an adhesion layer formation treatment,
a catalyst layer formation treatment, and
a catalyst activation treatment; followed by
a process of electroless plating.

2. The method of plating on a glass base plate according to claim 1, wherein the step of ultraviolet light irradiation treatment is conducted using ultraviolet light with a wavelength of at least 200 nm.

3. The method of plating on a glass base plate according to claim 1, wherein the step of ultraviolet light irradiation treatment is conducted using ultraviolet light with a wavelength between about 200 nm and 350 nm.

4. The method of plating on a glass base plate according to claim 1, wherein said electroless plating comprises plating a film having a thickness of at least 1 μm.

5. The method of plating on a glass base plate according to claim 1, wherein the etching treatment is conducted using hydrofluoric acid.

6. The method of plating on a glass base plate according to claim 1, wherein the adhesion layer formation treatment is conducted using a silane coupling agent.

7. The method of plating on a glass base plate according to claim 1, wherein the catalyst layer formation treatment is conducted using a palladium catalyst.

8. The method of plating on a glass base plate according to claim 1, wherein the catalyst activation treatment is conducted using hypophosphorous acid.

9. A method of plating on a glass base plate, the method comprising, in order:
treating a glass base plate with ultraviolet light having a wavelength between about 200 and 350 nm to break chemical bonds with alkaline and alkaline earth metals in the glass plate,
etching the glass plate with an acid to remove the alkaline and alkaline earth metals,
forming an adhesion layer on the etched glass plate with a silane coupling agent,
forming a catalyst layer on the adhesion layer,
activating the catalyst layer, and
electroless plating a layer on the activated catalyst layer.

10. A method according to claim 9, additionally comprising degreasing the glass base plate after the ultraviolet irradiation and before the acid etch.

11. A method according to claim 9, wherein the catalyst layer comprises palladium.

12. A method according to claim 11, wherein the catalyst layer is activated with a solution of hypophosphorous acid.

13. A method according to claim 9, wherein the glass plate is etched with both sulfuric acid and hydrofluoric acid.

14. A method of manufacturing a magnetic recording medium, the method comprising electroless plating on a glass' substrate employing the method of plating on a glass base plate according to claim 1, and then forming a magnetic recording layer on the electroless plating film.

15. A method of manufacturing a magnetic recording medium, the method comprising electroless plating of a soft magnetic layer on a glass substrate employing the method of plating according to claim 9, and then forming a magnetic recording layer on the electroless plating film.

16. A method according to claim 15, wherein the soft magnetic layer is at least 1 μm thick.
